(19) United States
(12) Patent Application Publication
(10) Pub. No.: US 2024/0330700 A1
(43) Pub. Date: Oct. 3, 2024

(54) SERVER AND AGENT FOR REPORTING OF COMPUTATIONAL RESULTS DURING AN ITERATIVE LEARNING PROCESS

(71) Applicant: Telefonaktiebolaget LM Ericsson (publ), Stockholm (SE)

(72) Inventors: Erik G. Larsson, LINKÖPING (SE); Reza Moosavi, LINKÖPING (SE); Henrik RYDÉN, Stockholm (SE)

(21) Appl. No.: 18/576,168

(22) PCT Filed: Jul. 6, 2021
(86) PCT No.: PCT/EP2021/068632

§ 371 Date: Jan. 3, 2024

(51) Int. Cl. G06N 3/092; G06N 3/0455

(52) U.S. Cl. CPC G06N 3/092; G06N 3/0455

(57) ABSTRACT

There is provided mechanisms for configuring agent entities with a reporting schedule for reporting computational results during an iterative learning process. A method is performed by a server entity. The method comprises configuring the agent entities with a computational task and a reporting schedule. The reporting schedule defines pairs of the agent entities. According to the reporting schedule and per each iteration of the learning process, each of the agent entities in each pair is to report its own computational result of the computational task to both the server entity and the other of the agent entities in the same pair. When reporting its own computational result to the server entity, each of the agent entities is to superimpose the computational result of the other of the agent entities in the same pair. The method comprises performing the iterative learning process with the agent entities until a termination criterion is met.

### TECHNICAL FIELD

Embodiments presented herein relate to a method, a server entity, a computer program, and a computer program product for configuring agent entities with a reporting schedule for reporting computational results during an iterative learning process. Embodiments presented herein further relate to a method, an agent entity, a computer program, and a computer program product for being configured by a server entity with a reporting schedule for reporting computational results during an iterative learning process.

### BACKGROUND

The increasing concerns for data privacy have motivated the consideration of collaborative machine learning systems with decentralized data where pieces of training data are stored and processed locally by edge user devices, such as user equipment. Federated learning (FL) is one non-limiting example of a decentralized learning topology, where multiple (possible very large number of) agents, for example implemented in user equipment, participate in training a shared global learning model by exchanging model updates with a centralized parameter server (PS), for example implemented in a network node.

FL is an iterative process where each global iteration, often referred to as communication round, is divided into three phases: In a first phase the PS broadcasts the current model parameter vector to all participating agents. The model parameter vector may for example comprise weights and biases of a neural network. In a second phase each of the agents performs one or several steps of a stochastic gradient descent (SGD) procedure on its own training data based on the current model parameter vector and obtains a model update. In a third phase the model updates from all agents are sent to the PS, which aggregates the received model updates and updates the parameter vector for the next iteration based on the model updates according to some aggregation rule. The first phase is then entered again but with the updated parameter vector as the current model parameter vector.

A common baseline scheme in FL is named Federated SGD, where in each local iteration, only one step of SGD is performed at each participating agent, and the model updates contain the gradient information. A natural extension is so-called Federated Averaging, where the model updates from the agents contain the updated parameter vector after performing their local iterations.

FL relies on the availability of communication links between the agents and the PS. In case a link between one of the agents and the PS is broken, for example because of fading of the radio channel, the PS is unable to obtain updates from this agent.

### SUMMARY

An object of embodiments herein is to address the above issues in order to enable efficient communication between the PS (hereinafter denoted server entity) and the agents (hereinafter denoted agent entities) so that the PS can obtain updates from all agents, even in situations of broken links.

According to a first aspect there is presented a method for configuring agent entities with a reporting schedule for reporting computational results during an iterative learning process. The method is performed by a server entity. The method comprises configuring the agent entities with a computational task and a reporting schedule. The reporting schedule defines pairs of the agent entities. According to the reporting schedule and per each iteration of the learning process, each of the agent entities in each pair is to report its own computational result of the computational task to both the server entity and the other of the agent entities in the same pair. When reporting its own computational result to the server entity, each of the agent entities is to superimpose the computational result of the other of the agent entities in the same pair. The method comprises performing the iterative learning process with the agent entities until a termination criterion is met.

According to a second aspect there is presented a server entity for configuring agent entities with a reporting schedule for reporting computational results during an iterative learning process. The server entity comprises processing circuitry. The processing circuitry is configured to cause the server entity to configure the agent entities with a computational task and a reporting schedule. The reporting schedule defines pairs of the agent entities. According to the reporting schedule and per each iteration of the learning process, each of the agent entities in each pair is to report its own computational result of the computational task to both the server entity and the other of the agent entities in the same pair. When reporting its own computational result to the server entity, each of the agent entities is to superimpose the computational result of the other of the agent entities in the same pair. The processing circuitry is configured to cause the server entity to perform the iterative learning process with the agent entities until a termination criterion is met.

According to a third aspect there is presented a server entity for configuring agent entities with a reporting schedule for reporting computational results during an iterative learning process. The server entity comprises a configure module configured to configure the agent entities with a computational task and a reporting schedule. The reporting schedule defines pairs of the agent entities. According to the reporting schedule and per each iteration of the learning process, each of the agent entities in each pair is to report its own computational result of the computational task to both the server entity and the other of the agent entities in the same pair. When reporting its own computational result to the server entity, each of the agent entities is to superimpose the computational result of the other of the agent entities in the same pair. The server entity comprises a process module configured to perform the iterative learning process with the agent entities until a termination criterion is met.

According to a fourth aspect there is presented a computer program for configuring agent entities with a reporting schedule for reporting computational results during an iterative learning process, the computer program comprising computer program code which, when run on processing circuitry of a server entity, causes the server entity to perform a method according to the first aspect.

According to a fifth aspect there is presented a method for is configured by a server entity with a reporting schedule for reporting computational results during an iterative learning process. The method is performed by an agent entity. The method comprises obtaining configuring in terms of a computational task and a reporting schedule from the server entity. The reporting schedule defines pairs of agent entities. The agent entity belongs to one of the pairs of agent entities. According to the reporting schedule and per each iteration of the learning process, each of the agent entities in each pair is to report its own computational result of the computational task to both the server entity and the other of the agent entities in the same pair. When reporting its own computational result to the server entity, each of the agent entities is to superimpose the computational result of the other of the agent entities in the same pair. The method comprises performing the iterative learning process with the server entity until a termination criterion is met. As part of performing the iterative learning process, the agent entity reports a computational result for an iteration of the learning process according to the reporting schedule.

According to a sixth aspect there is presented an agent entity for is configured by a server entity with a reporting schedule for reporting computational results during an iterative learning process. The agent entity comprises processing circuitry. The processing circuitry is configured to cause the agent entity to obtain configuring in terms of a computational task and a reporting schedule from the server entity. The reporting schedule defines pairs of agent entities. The agent entity belongs to one of the pairs of agent entities. According to the reporting schedule and per each iteration of the learning process, each of the agent entities in each pair is to report its own computational result of the computational task to both the server entity and the other of the agent entities in the same pair. When reporting its own computational result to the server entity, each of the agent entities is to superimpose the computational result of the other of the agent entities in the same pair. The processing circuitry is configured to cause the agent entity to perform the iterative learning process with the server entity until a termination criterion is met. As part of performing the iterative learning process, the agent entity reports a computational result for an iteration of the learning process according to the reporting schedule.

According to a seventh aspect there is presented an agent entity for is configured by a server entity with a reporting schedule for reporting computational results during an iterative learning process. The agent entity comprises an obtain module configured to obtain configuring in terms of a computational task and a reporting schedule from the server entity. The reporting schedule defines pairs of agent entities. The agent entity belongs to one of the pairs of agent entities. According to the reporting schedule and per each iteration of the learning process, each of the agent entities in each pair is to report its own computational result of the computational task to both the server entity and the other of the agent entities in the same pair. When reporting its own computational result to the server entity, each of the agent entities is to superimpose the computational result of the other of the agent entities in the same pair. The agent entity comprises a process module configured to perform the iterative learning process with the server entity until a termination criterion is met. As part of performing the iterative learning process, the agent entity reports a computational result for an iteration of the learning process according to the reporting schedule.

According to an eighth aspect there is presented a computer program for being configured by a server entity with a reporting schedule for reporting computational results during an iterative learning process, the computer program comprising computer program code which, when run on processing circuitry of an agent entity, causes the agent entity to perform a method according to the fifth aspect.

According to a ninth aspect there is presented a computer program product comprising a computer program according to at least one of the fourth aspect and the eighth aspect and a computer readable storage medium on which the computer program is stored. The computer readable storage medium could be a non-transitory computer readable storage medium.

Advantageously, these methods, these server entities, these agent entities, these computer programs, and this computer program product provide efficient communication between the server entity and the agent entities so that the server entity can obtain updates from all agent entities, even in situations of broken links.

Advantageously, these methods, these server entities, these agent entities, these computer programs, and this computer program product enables improved resilience against shadowing, blocking and fading in iterative learning processes where computational results are reported over wireless links. The improved resilience to fading will consequently lead to more agent entities participating in each iteration of the iterative learning processes. This in turns enables implies faster convergence and accuracy of the computational task.

Advantageously, these methods, these server entities, these agent entities, these computer programs, and this computer program product will not incur any extra signaling overhead in transmission of the computational results. In other words, the herein disclosed embodiments will increase the reliability of the transmission of the computational without any extra resource network usage and without any extra signaling overhead.

Other objectives, features and advantages of the enclosed embodiments will be apparent from the following detailed disclosure, from the attached dependent claims as well as from the drawings.

Generally, all terms used in the claims are to be interpreted according to their ordinary meaning in the technical field, unless explicitly defined otherwise herein. All references to “a/an/the element, apparatus, component, means, module, step, etc.” are to be interpreted openly as referring to at least one instance of the element, apparatus, component, means, module, step, etc., unless explicitly stated otherwise. The steps of any method disclosed herein do not have to be performed in the exact order disclosed, unless explicitly stated.

### BRIEF DESCRIPTION OF THE DRAWINGS

The inventive concept is now described, by way of example, with reference to the accompanying drawings, in which:

FIG. 1 is a schematic diagram illustrating a communication network according to embodiments;

FIGS. 2, 3 and 4 are signalling diagrams according to examples;

FIGS. 5 and 6 are flowcharts of methods according to embodiments;

FIGS. 7 and 8 are signalling diagrams according to embodiments;

FIG. 9 is a schematic illustration of a CSI compression process according to an embodiment;

FIG. 10 is a schematic diagram showing functional units of a server entity according to an embodiment;

FIG. 11 is a schematic diagram showing functional modules of a server entity according to an embodiment;

FIG. 12 is a schematic diagram showing functional units of an agent entity according to an embodiment;

FIG. 13 is a schematic diagram showing functional modules of an agent entity according to an embodiment;

FIG. 14 shows one example of a computer program product comprising computer readable means according to an embodiment;

FIG. 15 is a schematic diagram illustrating a telecommunication network connected via an intermediate network to a host computer in accordance with some embodiments; and

FIG. 16 is a schematic diagram illustrating host computer communicating via a radio base station with a terminal device over a partially wireless connection in accordance with some embodiments.

### DETAILED DESCRIPTION

The inventive concept will now be described more fully hereinafter with reference to the accompanying drawings, in which certain embodiments of the inventive concept are shown. This inventive concept may, however, be embodied in many different forms and should not be construed as limited to the embodiments set forth herein; rather, these embodiments are provided by way of example so that this disclosure will be thorough and complete, and will fully convey the scope of the inventive concept to those skilled in the art. Like numbers refer to like elements throughout the description. Any step or feature illustrated by dashed lines should be regarded as optional.

The wording that a certain data item, piece of information, etc. is obtained by a first device should be construed as that data item or piece of information being retrieved, fetched, received, or otherwise made available to the first device. For example, the data item or piece of information might either be pushed to the first device from a second device or pulled by the first device from a second device. Further, in order for the first device to obtain the data item or piece of information, the first device might be configured to perform a series of operations, possible including interaction with the second device. Such operations, or interactions, might involve a message exchange comprising any of a request message for the data item or piece of information, a response message comprising the data item or piece of information, and an acknowledge message of the data item or piece of information. The request message might be omitted if the data item or piece of information is neither explicitly nor implicitly requested by the first device.

The wording that a certain data item, piece of information, etc. is provided by a first device to a second device should be construed as that data item or piece of information being sent or otherwise made available to the second device by the first device. For example, the data item or piece of information might either be pushed to the second device from the first device or pulled by the second device from the first device. Further, in order for the first device to provide the data item or piece of information to the second device, the first device and the second device might be configured to perform a series of operations in order to interact with each other. Such operations, or interaction, might involve a message exchange comprising any of a request message for the data item or piece of information, a response message comprising the data item or piece of information, and an acknowledge message of the data item or piece of information. The request message might be omitted if the data item or piece of information is neither explicitly nor implicitly requested by the second device.

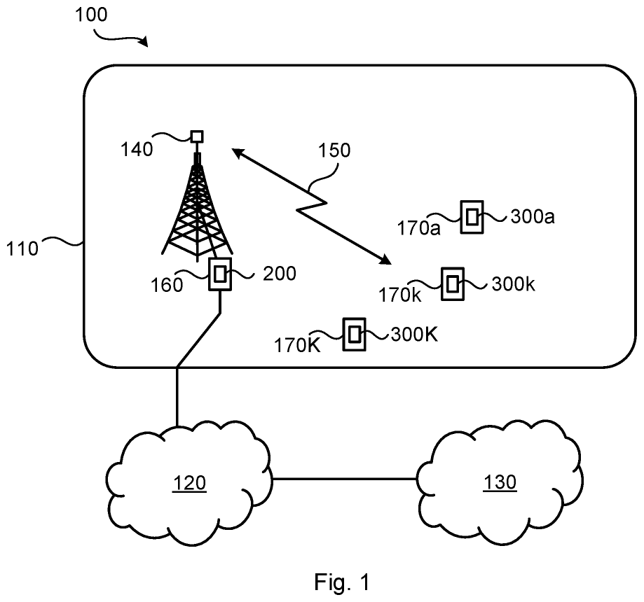

FIG. 1 is a schematic diagram illustrating a communication network 100 where embodiments presented herein can be applied. The communication network 100 could be a third generation (3G) telecommunications network, a fourth generation (4G) telecommunications network, a fifth (5G) telecommunications network, a sixth (6G) telecommunications network, and support any 3GPP telecommunications standard.

The communication network 100 comprises a transmission and reception point 140 configured to provide network access to user equipment 170a, 170k, 170K in an (radio) access network 110 over a radio propagation channel 150. The access network 110 is operatively connected to a core network 120. The core network 120 is in turn operatively connected to a service network 130, such as the Internet. The user equipment 170a:170K is thereby, via the transmission and reception point 140, enabled to access services of, and exchange data with, the service network 130.

Operation of the transmission and reception point 140 is controlled by a controller 160. The controller 160 might be part of, collocated with, or integrated with the transmission and reception point 140.

Examples of network nodes 160 are (radio) access network nodes, radio base stations, base transceiver stations, Node Bs (NBs), evolved Node Bs (eNBs), gNBs, access points, access nodes, and integrated access and backhaul nodes. Examples of user equipment 170a:170K are wireless devices, mobile stations, mobile phones, handsets, wireless local loop phones, smartphones, laptop computers, tablet computers, network equipped sensors, network equipped vehicles, and so-called Internet of Things devices.

It is assumed that the user equipment 170a:170K are to be utilized during an iterative learning process and that the user equipment 170a:170K as part of performing the iterative learning process are to report computational results to the network node 160. The network node 160 therefore comprises, is collocated with, or integrated with, a server entity 200. Each of the user equipment 170a:170K comprises, is collocated with, or integrated with, a respective agent entity 300a:300K.

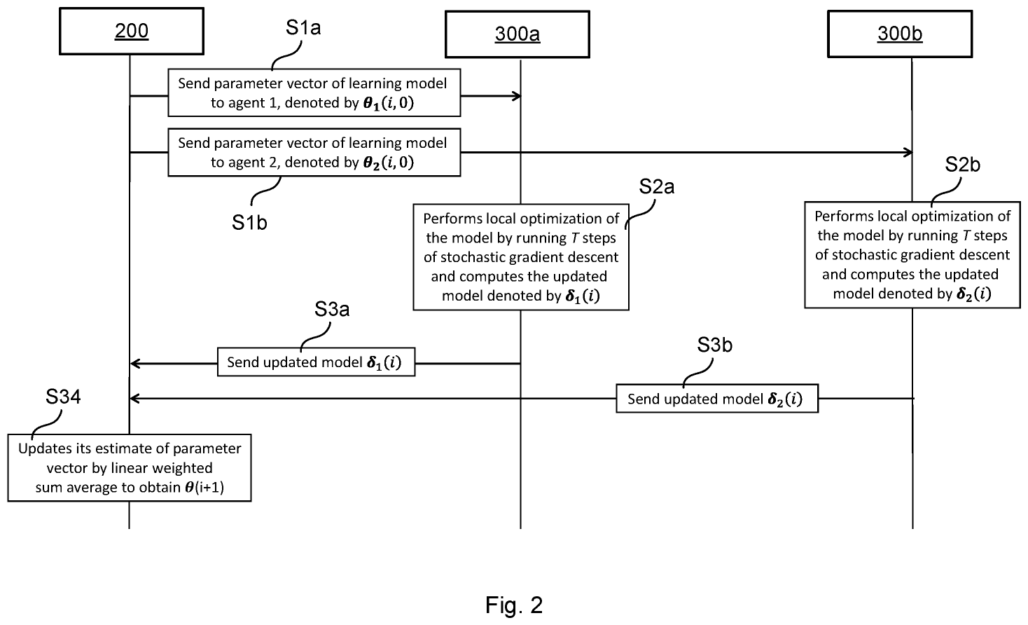

Reference is next made to the signalling diagram of FIG. 2, illustrating an example of a nominal iterative learning process. For simplicity, but without loss of generality, the example is shown for two agent entities 300a, 300b, but the principles hold also for larger number of agent entities 300a:300K.

The server entity 200 updates its estimate of the learning model, as defined by a parameter vector θ(i), by performing global iterations with an iteration time index i. At each iteration i, the following steps are performed:

Steps S1a, S1b: The server entity 200 broadcasts the parameter vector of the learning model, θ(i), to the agent entities 300a, 300b.

Steps S2a, S2b: Each agent entity 300a, 300b performs a local optimization of the model by running T steps of a stochastic gradient descent update on θ(i), based on its local training data;

$${θ}_{k} ( i , τ ) = {θ}_{k} ( i , τ - 1 ) - {η}_{k} ∇ {f}_{k} ( {θ}_{k} ( i , τ - 1 ) ) τ = 1 , … , T ,$$

where ηₖ is a weight and fₖ is the objective function used at agent entity k (and which is based on its locally available training data).

Steps S3a, S3b: Each agent entity 300a, 300b transmits to the server entity 200 their model update δₖ(i);

$${δ}_{k} ( i ) = {θ}_{k} ( i , T ) - {θ}_{k} ( i , 0 ) ,$$

where θₖ(i, 0) is the model that agent entity k received from the server entity 200. Steps S3a, S3b may be performed sequentially, in any order, or simultaneously.

Step S4: The server entity 200 updates its estimate of the parameter vector θ(i) by adding to it a linear combination (weighted sum) of the updates received from the agent entities 300a, 300b;

$$θ ( i + 1 ) = θ ( i ) + {w}_{1} {δ}_{1} ( i ) + {w}_{2} {δ}_{2} ( i )$$

where wₖ are weights.

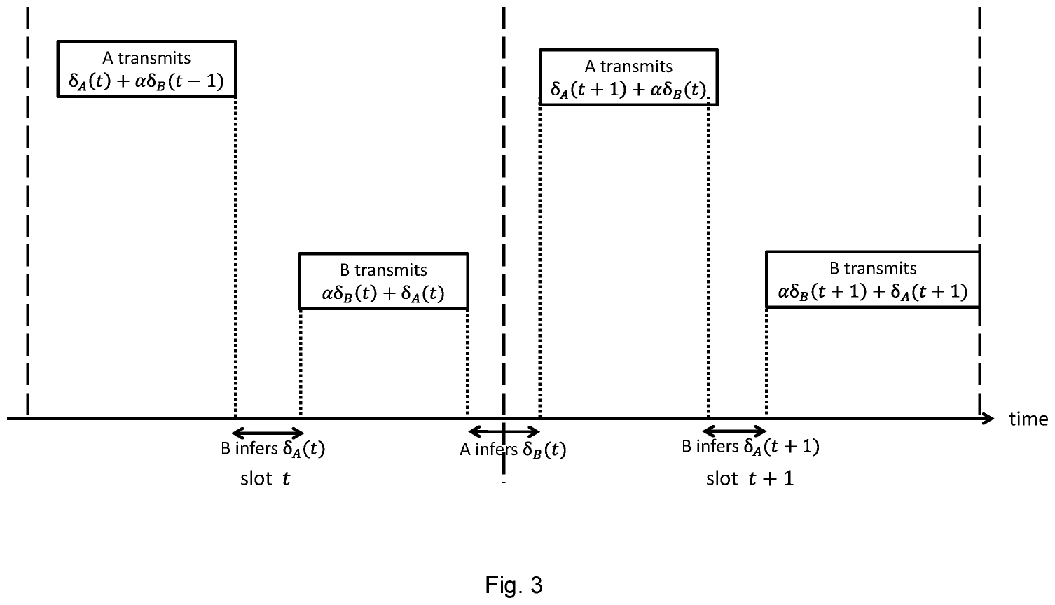

As disclosed above, in case a link between one of the agent entities 300a:300K and the server entity 200 is broken, for example because of fading of the radio channel, the server entity 200 is unable to obtain updates from this agent entity 300a:300K. To illustrate this further, reference is next made to the diagram of FIG. 3, illustrating a further example of a nominal iterative learning process. For simplification of notation but without loss of generality, it is assumed that there are two agent entities, denoted agent entity A and agent entity B, respectively. In this scheme agent entity A and agent entity B take turns in accessing the channel and transmitting their updates. Each agent entity A, B transmits with a nominal rate, say R_{A} and R_{B}. In time slot t, agent entity A transmits its update δ_{A}(t) and agent entity B transmits its update δ_{B}(t). Then, in time slot t+1, agent entity A transmits its update δ_{A}(t+1) and agent entity B transmits its update δ_{B}(t+1). This procedure is then repeated in time slot t+2 and so on. The transmission offers no protection from fading, so if one of the agent entities A, B has a poor channel to the server entity 200, the server entity 200 may fail in decoding the updates. Assuming, for example, that the link between agent entity A and the server entity 200 is broken for time slot t, this implies that, using the scheme in FIG. 3, the server entity 200 will never receive the update δ_{B}(t).

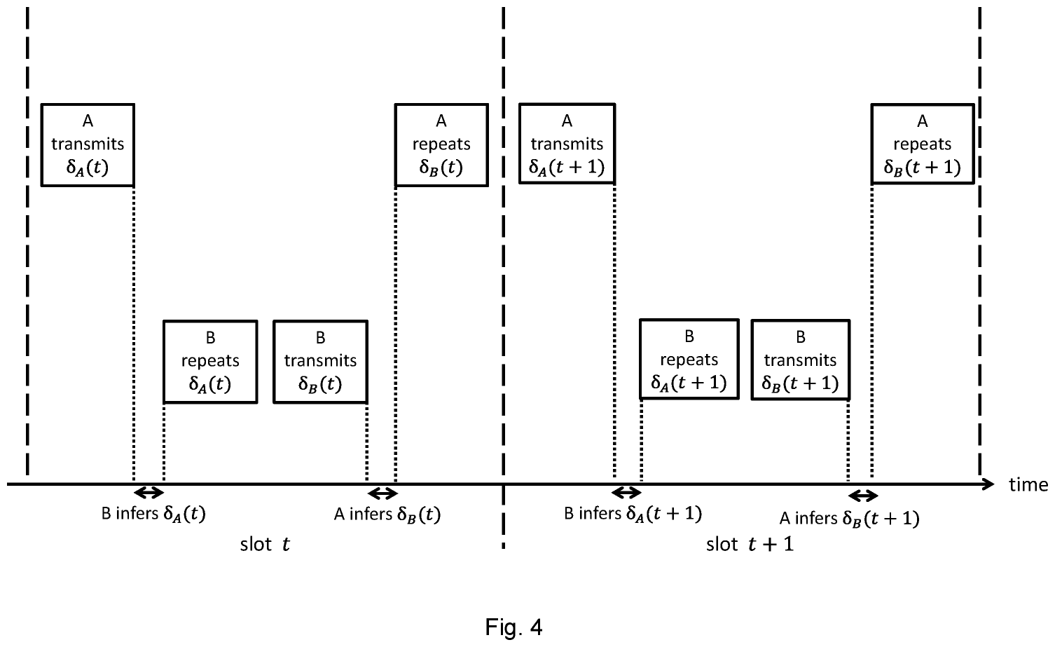

One possible remedy for this is illustrated in the diagram of FIG. 4, illustrating an example iterative learning process. In time slot t, agent entity A transmits its update δ_{A}(t). It is here assumed that agent entity B receives the update δ_{A}(t). Agent entity B in time slot t therefore forwards the update δ_{A}(t) and then transmits its own update δ_{B}(t). It is here assumed that agent entity A receives the update δ_{B}(t). Agent entity A in time slot t therefore forwards the update δ_{B}(t). Then, in time slot t+1, agent entity A transmits its update δ_{A}(t+1). It is here assumed that agent entity B receives the update δ_{A}(t+1). Agent entity B in time slot t+1 therefore forwards the update δ_{B}(t+1) and then transmits its own update δ_{B}(t+1). It is here assumed that agent entity A receives the update δ_{B}(t+1). Agent entity A in time slot t+1 therefore forwards the update δ_{B}(t+1). This procedure is then repeated in time slot t+2 and so on. Assuming that the link between agent entity A and the server entity 200 is broken for time slot t, this implies that, using the scheme in FIG. 4, the server entity 200 will receive the update δ_{A}(t) as forwarded by agent entity B. Hence the communication is protected from a deep fade of the links. That is, if for example the link from agent entity B to the server entity 200 is blocked, agent entity B will help out by forwarding the update from agent entity A. In the language of diversity, second order diversity is thus achieved. One drawback is that both agent entities A, B need to transmit their updates in half the time, i.e., with double the rates, 2R_{A} and 2R_{B}, respectively, which will increase error rates or require a higher transmit power. Otherwise reliability might be compromised. This is of particular concern when the number of agent entities increases. One object of the herein disclosed embodiments is to address this drawback.

The embodiments disclosed herein therefore relate to mechanisms for a server entity 200 to configure agent entities 300a:300K with a reporting schedule for reporting computational results during an iterative learning process and for an agent entity 300k to be configured by a server entity 200 with a reporting schedule for reporting computational results during an iterative learning process. In order to obtain such mechanisms there is provided a server entity 200, a method performed by the server entity 200, a computer program product comprising code, for example in the form of a computer program, that when run on processing circuitry of the server entity 200, causes the server entity 200 to perform the method. In order to obtain such mechanisms there is further provided an agent entity 300k, a method performed by the agent entity 300k, and a computer program product comprising code, for example in the form of a computer program, that when run on processing circuitry of the agent entity 300k, causes the agent entity 300k to perform the method.

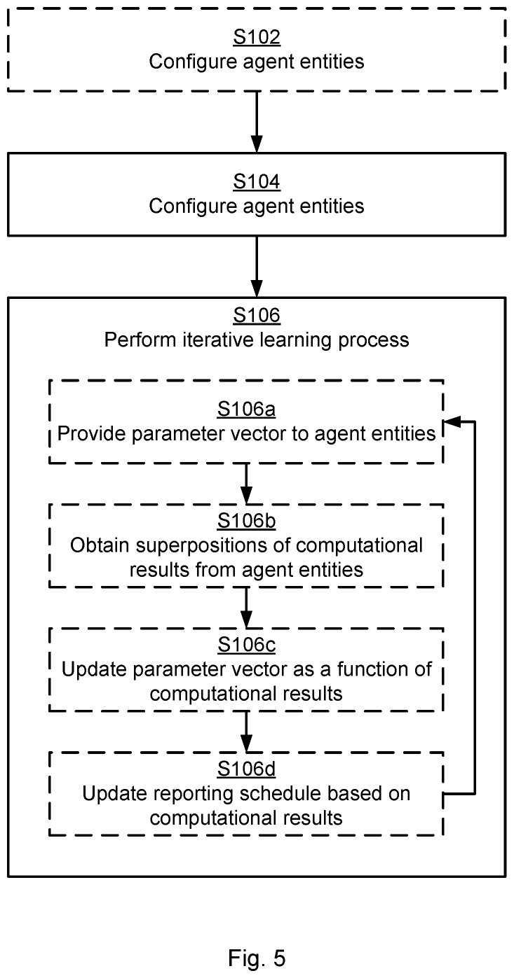

Reference is now made to FIG. 5 illustrating a method for configuring agent entities 300a:300K with a reporting schedule for reporting computational results during an iterative learning process as performed by the server entity 200 according to an embodiment.

S104: The server entity 200 configures the agent entities 300a:300K with a computational task and a reporting schedule.

In short, the method is based on that the server entity 200 configures the agent entities 300a:300K with a reporting schedule that specifies that the computational results are to be reported using superpositioning.

In particular, the reporting schedule defines pairs of the agent entities 300a:300K. According to the reporting schedule and per each iteration of the learning process, each of the agent entities 300a:300K in each pair is to report its own computational result of the computational task to both the server entity 200 and the other of the agent entities 300a:300K in the same pair. According to the reporting schedule and per each iteration of the learning process, when reporting its own computational result to the server entity 200, each of the agent entities 300a:300K is to superimpose the computational result of the other of the agent entities 300a:300K in the same pair.

S106: The server entity 200 performs the iterative learning process with the agent entities 300a:300K until a termination criterion is met.

The termination criterion in some non-limiting examples can be when a pre-determined number of iterations have been reached or when the aggregated loss function has reached a desired value or when it does not decrease after one (or several round) of iterations. The loss function itself represents a prediction error, such as mean square error or mean absolute error.

The robustness of sending updates, in terms of computational results, from the agent entities 300a:300K to the server entity 200 is thereby improved. The herein disclosed embodiments are based on that in some communication systems, such as in wireless communication systems, the user equipment 170a:170K can often overhear the transmissions of one another. Using this fact, agent entities 300a:300K are grouped into pairs of agent entities 300a;300K. In each pair, each agent entity 300a:300K acts as a relay for the other agent entity 300a:300K in the same pair. Moreover, given that the server entity 200 is interested in the aggregated message from the agent entities 300a:300K, the messages can be sent simultaneously using superposition. The superposition principle is thus applied in a pairwise manner. The proposed techniques will thus have no signaling overhead compared to sending the updates individually by each agent entities 300a;300K.

Embodiments relating to further details of configuring agent entities 300a:300K with a reporting schedule for reporting computational results during an iterative learning process as performed by the server entity 200 will now be disclosed.

In general terms, the server entity 200 configures the agent entities 300a:300K with the computational task and the reporting schedule by providing information, or instructions, that defines the computational task and the reporting schedule to the agent entities 300a:300K. This information, or these instructions, thus enable(s) the agent entities 300a:300K to perform the computational task and to report their computational results of the computational task to the server entity 200 in accordance with the reporting schedule.

There may be different ways to for the server entity 200 to pair the agent entities 300a:300K. Aspects relating to will now be disclosed.

In some non-limiting examples, which of the agent entities 300a:300K to be paired with each other is dependent on at least one of the following factors: the channel quality between the server entity 200 and each of the agent entities 300a:300K, the channel quality between the agent entities 300a:300K themselves, the geographical location of each of the agent entities 300a:300K, the device information of each of the agent entities 300a:300K, the device capability of each of the agent entities 300a:300K, the amount of data locally obtainable by of each of the agent entities 300a:300K.

Properties of these factors will now be disclosed.

In terms of radio channel characteristics, when two agent entities 300a:300K have signal quality below a certain threshold, these two agent entities 300a:300K can be paired with the goal to achieve diversity. Further terms of radio channel characteristics, when one agent entity 300a:300K has a signal quality below a certain threshold and the and another agent entity 300a:300K has a signal quality above a desired threshold, these agent entities 300a:300K can be paired since the agent entity 300a:300K with the signal quality above the desired threshold could help forwarding the computational results of the agent entity 300a:300K having the signal quality below the certain threshold. Further terms of radio channel characteristics, when two agent entities 300a:300K can overhear each other at a signal quality above a desired threshold, these agent entities 300a:300K can be paired. The agent entities 300a:300K can therefore be configured to listen on uplink reference signal transmissions from other agent entities 300a:300K, for example a random access (RA) preamble or a sounding reference signal (SRS). The radio channel characteristics might be defined, or in other ways based on, statistics of signal to interference plus noise ratio (SINR) as gather over a certain time duration, as an agent entity 300a:300K with high SINR variation can risk having more deep fading events (out-of-coverage).

In terms of geographical information, an agent entity 300a:300K can be configured to listen/transmit in certain time-frequency resources where the computational result is expected to be transmitted/received by another agent entity 300a:300K. In some examples, the time-frequency resources are associated to a certain radiolocation (such as the device-serving signal, such as a synchronization signal block (SSB), or a channel state information reference signal (CSI-RS)). Two agent entities 300a:300K that share the same device-serving signal can then be paired. In some examples, the agent entities 300a:300K are paired based on geolocation information of each agent entity 300a:300K or sensor data (e.g., indicating that two agent entities 300a:300K are travelling in the same vehicle).

Device information could refer to the type of device in which each agent entity 300a:300K resides. Two agent entities 300a:300K residing in the same type of device could then be paired. For security reasons it might not be desirable, or even possible, for one device type to overhear another device-type. Device information could refer to the traffic types/characteristics, or expected lifetime, of the device in which each agent entity 300a:300K resides. Two agent entities 300a:300K residing in devices with similar traffic types/characteristics, or expected lifetime, could then be paired.

With respect to the amount of data locally obtainable by of each of the agent entities 300a:300K, some of the agent entities 300a:300K might contribute more to the overall computational task by having more relevant information than others. Hence, agent entities 300a:300K that contribute more to the overall computational taskt than others can be configured with superpositioning for improved resilience. For example, agent entities 300a:300K that have large dataset describing the relation between two carriers (e.g., when the computational task pertains to secondary carrier prediction), or large sequence of measurements that will detect a coverage hole can be selected to be paired for reporting, either with each other or with other agent entities 300a:300K.

In order for the server entity 200 to pair the agent entities 300a:300K the server entity 200 might need to gather information, in terms of parameters affecting the pairing, from the agent entities 300a:300K. Particularly, in some embodiments, the server entity 200 is configured to perform (optional) step S102:

S102: The server entity 200 configures the agent entities 300a:300K to, to the server entity 200, report parameters affecting pairing of the agent entities 300a:300K.

These parameters might reflect any of: each agent entity's hearability of other agent entities 300a:300K, each agent entity's own support of superposition, each agent entity's superpositioning capabilities, each agent entity's allowability of superposition.

In this respect, some of the parameters affecting pairing of the agent entities 300a:300K generally corresponds to the above-disclosed factors based on which the pairing is made. In particular, in some non-limiting examples, the parameters affecting the pairing pertain to at least one of the following: the channel quality between the server entity 200 and each of the agent entities 300a:300K, the channel quality between the agent entities 300a:300K themselves, the geographical location of each of the agent entities 300a:300K, the device information of each of the agent entities 300a:300K, the device capability of each of the agent entities 300a:300K, the amount of data locally obtainable by of each of the agent entities 300a:300K. The agent entities 300a:300K might thus report their capabilities in supporting an iterative learning process based on superpositioned reporting of computational results.

Further, the server entity 200 might configure at least some of the agent entities 300a:300K with beamforming and power control configurations. The actual beamforming and power control might then be executed by the user equipment 170a:170K in which the agent entities 300a:300K are residing. The beamforming and power control aims at increasing the hearability of the agent entities 300a:300K with respect to each other. Further, the agent entities 300a:300K might be configured with a power control configuration with an aim to save energy when transmitting the computational results. This is since the resilience of the transmission towards the server entity 200 increases when the computational results of each agent entity 300a:300K in the pair are transmitted via both agent entities 300a:300K in the pair. The beamforming and/or power control configuration can for example be based on overheard RA preambles and/or uplink reference signals.

There may be different ways to perform the iterative learning process. In some embodiments, the server entity 200 is configured to perform (optional) actions S106a, S106b, S106c during each iteration of the iterative learning process (in action S106):

S106a: The server entity 200 provides a parameter vector of the computational task to the agent entities 300a:300K.

S106b: The server entity 200 obtains, according to the reporting schedule, superpositions of computational results as a function of the parameter vector from the agent entities 300a:300K.

S106c: The server entity 200 updates the parameter vector as a function of an aggregate of the obtained computational results when the aggregate of the obtained computational results for the iteration fails to satisfy the termination criterion.

In some aspects, the reporting schedule, for example in terms of pairings of the agent entities 300a:300K, based on reports with the computational results, as well as statistics, and/or other types of feedback. Particularly, in some embodiments, the server entity 200 is configured to perform (optional) step S102:

S106d: The server entity 200 updates the reporting schedule for a next iteration of the iterative learning process based on the computational results received for a current iteration of the iterative learning process.

The server entity 200 could thus use feedback information from the superpositioning procedure to update whether to continue transmission of reports from the agent entities 300a:300K using superpositioning. For example, if a first agent entity 300a:300K and a second agent entity 300a:300K has not overheard each other above a certain threshold a certain number of times in a previous time-window, the server entity might either deactivate transmission of reports using superpositioning from the first and second agent entities 300a:300K or try to pair the first and second agent entities 300a:300K with other agent entities 300a:300K (based on any of the factors disclosed above).

So far, for the simplicity of exposition, the inventive concept for iterative learning process has been presented with the updating of the parameter vector as a function of an aggregate of the obtained computational results based on a sum. In this respect, the sum might be a weighted sum where the server entity 200 for the iteration with time index t updates its estimate of the parameter vector θ(t+1) according to:

$$θ ( t + 1 ) = θ ( t ) + {w}_{A} {δ}_{A} ( t ) + {w}_{B} {δ}_{B} ( t )$$

The weights w_{A}, w_{B} could then be communicated to the agent entities 300a:300K prior to starting the iterative learning process. This is because the server entity 200 receives the aggregated sum and hence might not be able to separate individual messages (i.e. δ_{A}(t) and δ_{B}(t)) from each other. In general terms, since there are K agent entities there are also K weights; and weight k is for agent entity 300k. The weights w₁, w₁, . . . , w_{K} are used to reflect the importance of contributions from each of the agent entities 300a:300K. For example, if agent entity 300i is known a priori to have more relevant local data than agent entity 300j, then wᵢ>wⱼ. In some examples, the weights w₁, w₁, . . . , w_{K} can be updated after each iteration round based on the relative magnitude of model updates from each of the agent entities 300a:300K.

Therefore, in some aspects, each agent entity 300a:300K needs to multiply its computational result with the corresponding weight. Particularly, in some embodiments, according to the reporting schedule, each of the agent entities 300a:300K in each pair is configured to, as part of superimposing the computational result of the other of the agent entities 300a:300K, weighting its own computational result with a first weighting factor and weighting the computational result of the other of the agent entities 300a:300K with a second weighting factor.

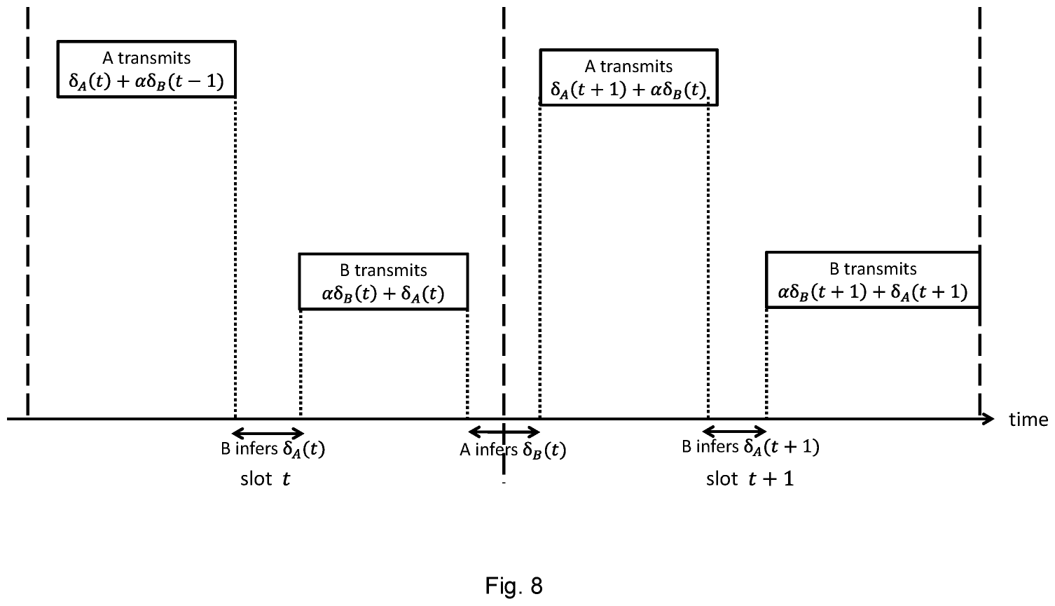

In order to decrease the signaling overhead associated with transmission of weights to the agent entities 300a:300K, in some aspects, the server entity 200 only transmits the ratio of weights to one of the agent entities 300a:300K. Particularly, in some embodiments, according to the reporting schedule, only one of the agent entities 300a:300K in each pair is configured to, as part of superimposing the computational result of the other of the agent entities 300a:300K, weighting its own computational result with a first weighting factor and weighting the computational result of the other of the agent entities 300a:300K with a second weighting factor. This embodiment is illustrated in FIG. 8 which will be described in more detail below.

It is noted that in a real deployment, all transmissions from the agent entities 300a:300K are not always successful. The thus far disclosed embodiments can be used for increasing robustness of an iterative learning process. This is because any sporadic erroneous reception of computational results at the server entity 200 will not affect the overall averaging in the long run. That is, over longer time, the server entity 200 will still infer the sum:

$${\sum }_{t} 2 \cdot ( {δ}_{A} ( t ) + {δ}_{B} ( t ) ) .$$

Further, if one of the links are permanently blocked, the server entity 200 will, over longer time, infer the sum:

$${\sum }_{t} ( {δ}_{A} ( t ) + {δ}_{B} ( t ) ) .$$

However, if blockage occurs frequently, this will affect the summation at the server entity 200. In such situations, and in order to achieve proper operating conditions, the server entity 200 might disregard reports of the computational results as received on an unstable link. In particular, in some embodiments, as part of performing the iterative learning process with the agent entities 300a:300K, the computational results of the agent entities 300a:300K are received over wireless links, where the server entity 200 obtains link quality measurements of the wireless links, and where any computational result received over a wireless link with a link quality, as indicated by the link quality measurement for said wireless link, is below a quality threshold is disregarded. This to ensure that, over long-term, the server entity 200 will still infer the sum:

$${\sum }_{t} ( {δ}_{A} ( t ) + {δ}_{B} ( t ) ) .$$

In this respect, the server entity 200 might determine to disregard reports from a certain agent entity 300a:300K by measuring, or estimating, the quality of the link to this certain agent entity 300a:300K. Existing techniques for channel estimation can be used for this purpose.

It is here further noted that there might be scenarios where one of the agents 300a:300K is not able to correctly and in time receive the report of the computational result from the other agent entity 300a:300K in the same pair. If this occurs sporadically, it will have only very limited impact on the overall performance and over longer time, the server entity 200 will still infer the sum:

$${\sum }_{t} 2 \cdot ( {δ}_{A} ( t ) + {δ}_{B} ( t ) ) .$$

However, if the problem persists for an extended period, say agent entity A is not able to correctly and in time receive the report from agent entity B, then agent entity B can still act as relay and deploy the proposed scheme. However, if the server entity 200 is not informed about this situation, then over longer time, the server entity 200 will infer the sum:

$${\sum }_{t} ( 2 \cdot {δ}_{A} ( t ) + {δ}_{B} ( t ) ) .$$

To avoid this situation, in some aspects, each agent 300a:300K is configured to set a flag, or include another type of indication, to indicate whether it was able to correctly and in time receive the report of the computational result from the other agent entity 300a:300K in the same pair and consequently performed superpositioning or not. Hence, in some embodiments, according to the reporting schedule, the agent entities 300a:300K are configured to, when reporting their own computational result to the server entity 200, indicate whether the computational result of the other of the agent entities 300a:300K in the same pair has been superimposed or not. This indication can be implemented by setting a flag. In this case, the server entity 200 can then take appropriate actions. For example, the server entity 200 might disregard the computational results where the agent entities 300a:300K were not able to perform superpositioning, or rearrange the pairing of the agent entities 300a:300K if the situation remains the same for a predefine period of time.

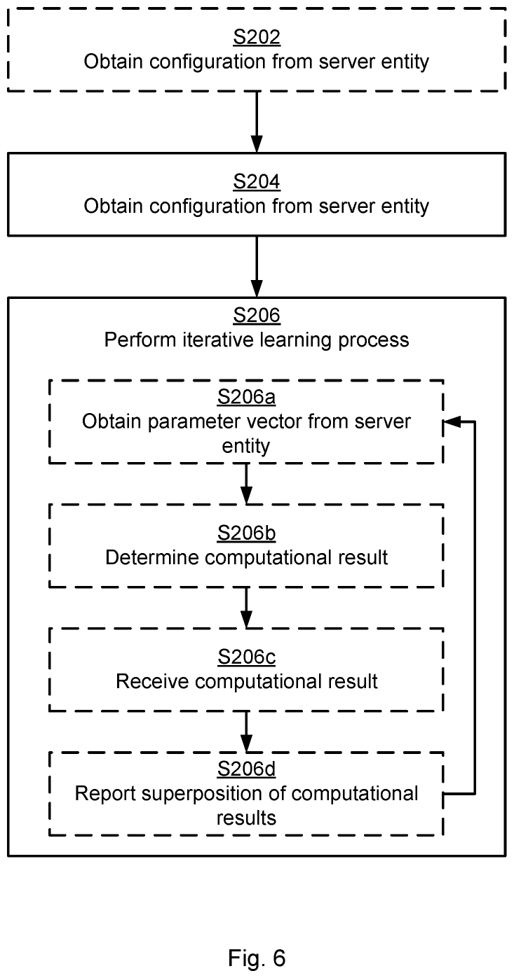

Reference is now made to FIG. 6 illustrating a method for being configured by a server entity 200 with a reporting schedule for reporting computational results during an iterative learning process as performed by the agent entity 300k according to an embodiment.

As disclosed above, the server entity 200 configured the agent entities 300a:300K with a computational task and a reporting schedule.

S202: The agent entity 300k obtains configuring in terms of a computational task and a reporting schedule from the server entity 200.

As disclosed above, the reporting schedule defines pairs of agent entities 300a:300K. The agent entity 300k belongs to one of the pairs of agent entities 300a:300K. As disclosed above, according to the reporting schedule and per each iteration of the learning process, each of the agent entities 300a:300K in each pair is to report its own computational result of the computational task to both the server entity 200 and the other of the agent entities 300a:300K in the same pair. When reporting its own computational result to the server entity 200, each of the agent entities 300a:300K is to superimpose the computational result of the other of the agent entities 300a:300K in the same pair.

S206: The agent entity 300k performs the iterative learning process with the server entity 200 until a termination criterion is met. As part of performing the iterative learning process, the agent entity 300k reports a computational result for an iteration of the learning process according to the reporting schedule.

Embodiments relating to further details of being configured by a server entity 200 with a reporting schedule for reporting computational results during an iterative learning process as performed by the agent entity 300k will now be disclosed.

As disclosed above, the server entity 200 might need to gather information, in terms of parameters affecting the pairing, from the agent entities 300a:300K. Therefore, in some embodiments, the agent entity 300k is configured to perform (optional) step S202:

S202: The agent entity 300k obtains configuring from the server entity 200 to, to the server entity 200, report parameters affecting pairing of the agent entity 300k.

As disclosed above, in some non-limiting examples, the parameters affecting the pairing pertain to at least one of: the channel quality between the server entity 200 and the agent entity 300k, the channel quality between the agent entity 300k and other agent entities 300a:300K, the geographical location of the agent entity 300k, the device information of the agent entity 300k, the device capability of the agent entity 300k, the amount of data locally obtainable by the agent entity 300k.

As disclosed above, in some aspects, weights w_{A}, w_{B} are communicated to the agent entities 300a:300K prior to starting the iterative learning process. Particularly, in some embodiments, according to the reporting schedule, the agent entity 300k is configured to, as part of superimposing the computational result of the other of the agent entities 300a:300K, weighting its own computational result with a first weighting factor and weighting the computational result of the other of the agent entities 300a:300K with a second weighting factor.

As disclosed above, there may be different ways to perform the iterative learning process. In some embodiments, the agent entity 300k is configured to perform (optional) actions S206a, S206b, S206c, S206d during each iteration of the iterative learning process (in action S206):
S206a: The agent entity 300k obtains a parameter vector of the computational problem from the server entity 200.
S206b: The agent entity 300k determines the computational result of the computational task as a function of the obtained parameter vector for the iteration, of data locally obtained by the agent entity 300k.
S206c: The agent entity 300k receives any computational result of the computational task from the other of the agent entities 300a:300K in the same pair for the iteration.
S206d: The agent entity 300k reports a superposition of its own computational result with the computational result of the computational task from the other of the agent entities 300a:300K in the same pair to the server entity 200 according to the reporting schedule.

Further aspects of how the agent entity 300k might perform the iterative learning process will now be disclosed.

As noted in S206c and S206d, the agent entity 300k superpositions its own computational result with the computational result of the computational task from the other agent entity 300a:300K in the same pair. In this respect, the computational result as received from the other agent entity 300a:300K in turn comprises a superposition of the computational result of the other agent entity 300a:300K and the computational result of the agent entity 300k from the previous iteration. The computational result of the agent entity 300k from the previous iteration should thus be removed. Hence, the agent entity 300k might, from the computational result of the other agent entity 300a:300K, subtract a term representing its own computational result from the previous iteration. That is, in some embodiments, the received computational result for a current iteration is composed of a superposition of the computational result as determined by the other of the agent entities 300a:300K in the same pair for the current iteration and the computational result as determined by the agent entity 300k itself for a previous-most iteration. The computational result as determined by the agent entity 300k itself for the previous-most iteration is subtracted from the received computational result before being superpositioned with the computational result as determined by the agent entity 300k for the current iteration.

It is here further noted that the superpositioning can be performed without the agent entity 300k knowing the actual data of the computational result as received from the other agent entity 300a:300K. That is, the received computational result can be superpositioned with the computational result as determined by the agent entity 300k itself without the agent entity 300k interpreting, or accessing, any data provided in the received computational result.

As disclosed above, in some aspects, each agent 300a:300K is configured to set a flag, or include another type of indication, to indicate whether it was able to correctly and in time receive the report of the computational result from the other agent entity 300a:300K in the same pair and consequently performed superpositioning or not. Hence, in some embodiments, according to the reporting schedule, the agent entity 300k is configured to, when reporting its own computational result to the server entity 200, indicate whether the computational result of the other of the agent entities 300a:300K in the same pair has been superimposed or not.

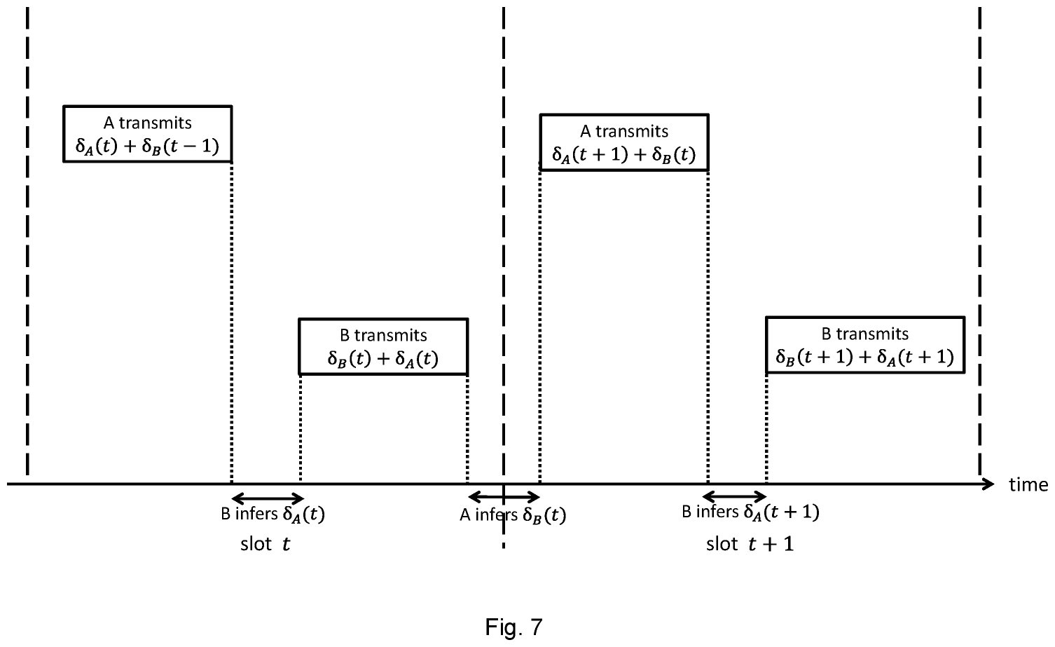

A first particular embodiment for performing an iterative learning process based on at least some of the above disclosed embodiments will now be disclosed in detail with reference to the scheme of FIG. 7. For simplification of notation but without loss of generality, it is assumed that there are two agent entities, denoted agent entity A and agent entity B, respectively. It is assumed that each time slot corresponds to one iteration of the iterative learning process and hence the terms time slot and iteration can be used interchangeably.

In time slot t, agent entity A transmits a superposition of its own update δ_{A}(t) for time slot t and the update δ_{B}(t−1) from agent entity B for time slot t−1. It is here assumed that agent entity B receives the update δ_{A}(t)+δ_{B}(t−1). Agent entity B in time slot t subtracts the term δ_{B}(t−1) from the received report from agent entity A and then transmits a superposition of its own update δ_{B}(t) for time slot t and the update δ_{A}(t) from agent entity A for time slot t. It is here assumed that agent entity A receives the update δ_{B}(t)+δ_{A}(t). Agent entity A in time slot t subtracts the term δ_{A}(t) from the received report from agent entity B and then transmits a superposition of its own update δ_{A}(t+1) for time slot t+1 and the update δ_{B}(t) from agent entity B for time slot t. It is here assumed that agent entity B receives the update δ_{A}(t+1)+δ_{B}(t). Agent entity B in time slot t subtracts the term δ_{B}(t) from the received report from agent entity A and then transmits a superposition of its own update δ_{B}(t+1) for time slot t+1 and the update δ_{A}(t+1) from agent entity A for time slot t+1. It is here assumed that agent entity A receives the update δ_{B}(t+1)+δ_{A}(t+1). For both time slots t and t+1 the server entity 200, in case the link between agent entity A and the server entity 200 and the link between agent entity B and the server entity 200 are both fully operational, aggregates (i.e., sums over time) all received data. Thus, over longer time, the server entity 200 will infer the sum:

$${\sum }_{t} 2 \cdot ( {δ}_{A} ( t ) + {δ}_{B} ( t ) ) .$$

The factor two appears because each update is received twice (once from each of the agent entities A, B). This also could help average out noise.

Assume now that the link from agent entity B to the server entity 200 is blocked, or otherwise broken. Then, just by aggregating the data received from agent entity A, the server entity 200 can still infer (over longer time) the sum:

$${\sum }_{t} ( {δ}_{A} ( t ) + {δ}_{B} ( t ) ) .$$

That is, the same sum as before but without the factor two.

A second particular embodiment for performing an iterative learning process based on at least some of the above disclosed embodiments will now be disclosed in detail with reference to the scheme of FIG. 8. For simplification of notation but without loss of generality, it is assumed that there are two agent entities, denoted agent entity A and agent entity B, respectively. It is assumed that each time slot corresponds to one iteration of the iterative learning process and hence the terms time slot and iteration can be used interchangeably.

The scheme of FIG. 8 differs from the scheme of FIG. 7 in terms of the use of weights w_{B}/w_{A}. Particularly, in the scheme of FIG. 8 the server entity 200 has sent the ratio α=w_{B}/w_{A} to agent entity B. Agent entity B then applies this ratio to its updates. Since the update from agent entity B are propagated also to agent entity A, the ratio α will appear also for the updates of agent entity B at agent entity A although agent entity A might be unaware of the ratio α or even that agent entity B applies such a ratio to its updates.

In time slot t, agent entity A transmits a superposition of its own update δ_{A}(t) for time slot t and the update αδ_{B}(t−1) from agent entity B for time slot t−1. It is here assumed that agent entity B receives the update δ_{A}(t)+αδ_{B}(t−1). Agent entity B in time slot t subtracts the term αδ_{B}(t−1) from the received report from agent entity A and then transmits a superposition of its own update αδ_{B}(t) for time slot t and the update δ_{A}(t) from agent entity A for time slot t. It is here assumed that agent entity A receives the update αδ_{B}(t)+δ_{A}(t). Agent entity A in time slot t subtracts the term δ_{A}(t) from the received report from agent entity B and then transmits a superposition of its own update δ_{A}(t+1) for time slot t+1 and the update αδ_{B}(t) from agent entity B for time slot t. It is here assumed that agent entity B receives the update δ_{A}(t+1)+αδ_{B}(t). Agent entity B in time slot t subtracts the term αδ_{B}(t) from the received report from agent entity A and then transmits a superposition of its own update αδ_{B}(t+1) for time slot t+1 and the update δ_{A}(t+1) from agent entity A for time slot t+1. It is here assumed that agent entity A receives the update αδ_{B}(t+1)+δ_{A}(t+1). For both time slots t and t+1 the server entity 200, in case the link between agent entity A and the server entity 200 and the link between agent entity B and the server entity 200 are both fully operational, aggregates (i.e., sums over time) all received data. Upon reception of the updates, the server entity 200 multiply each update with the weight w_{B}. Thus, over longer time, the server entity 200 will infer the sum:

$${\sum }_{t} 2 \cdot ( {w}_{A} {δ}_{A} ( t ) + {w}_{B} {δ}_{B} ( t ) ) .$$

Illustrative examples where the herein disclosed embodiments apply will now be disclosed.

According to a first example, the computational task pertains to prediction of best secondary carrier frequencies to be used by user equipment 170a:170K in which the agent entities 300a:300K are provided. The data locally obtained by the agent entity 300k can then represent a measurement on a serving carrier of the user equipment 170k. In this respect, the best secondary carrier frequencies for user equipment 170a:170K can be predicted based on their measurement reports on the serving carrier. The secondary carrier frequencies as reported thus defines the computational result. In order to enable such a mechanism, the agent entities 300a:300K can be trained by the server entity 200, where each agent entity 300k takes as input the measurement reports on the serving carrier(s) (among possibly other available reports such as timing advance, etc.) and as outputs a prediction of whether the user equipment 170k in which the agent entity 300k is provided has coverage or not in the secondary carrier frequency.

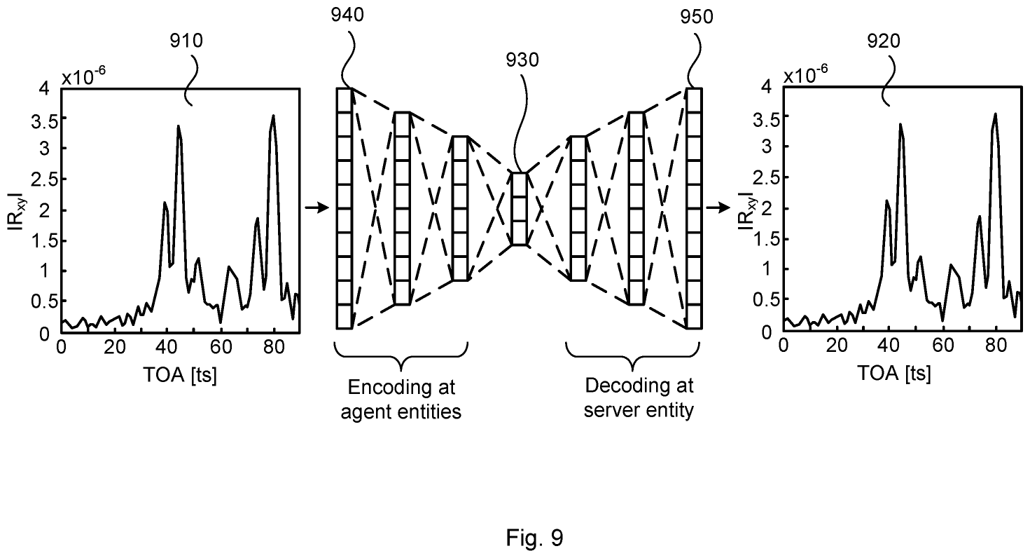

According to a second example, the computational task pertains to compressing channel-state-information using an auto-encoder, where the server entity 200 implements a decoder of the auto-encoder, and where each of the agent entities 300a:300K implements a respective encoder of the auto-encoder. An autoencoder can be regarded as a type of neural network used to learn efficient data representations (denoted by code hereafter). One example of an autoencoder comprising an encoder/decoder for CSI compression is shown in the block diagram of FIG. 9. In this example, the absolute values of the Channel Impulse Response (CIR), as represented by input 940, are, at the agent entities 300a:300K, compressed to a code 930, and then the resulting code is, at the server entity 200, decoded to reconstruct the measured CIR, as represented by output 950. The reconstructed CIR 920 is almost identical to the original CIR 910. The CIR 910, 920 is plotted in terms of the magnitude of the cross-correlation |R_{xy}| between a transmit signal and a receive signal as a function of time of arrival (TOA) in units of the physical layer time unit Ts, where 1 Ts= 1/30720000 seconds. In practice, instead of transmitting raw CIR values from the user equipment 170a:170K to the network node 160, the agent entities 300a:300K thus encode the raw CIR values using the encoders and report the resulting code to the server entity 200. The code as reported thus defines the computational result. The server entity 200, upon reception of the code from the agent entities 300a:300K, reconstructs the CIR values using the decoder. Since the code can be sent with fewer information bits, this will result in significant signaling overhead reduction. The reconstruction accuracy can be further enhanced if as many independent agent entities 300a:300K as possible are utilized. This can be achieved by enabling each agent entity 300k to contribute to training a global model preserved at the server entity 200. In particular, the herein disclosed embodiments that achieve added resilience to the reporting of computational results during the iterative learning process can be used to increase the compression and thus gives better beamforming/positioning.

According to a third example, the computational task pertains to signal quality drop prediction. The signal quality drop prediction is based on measurements on wireless links used by user equipment 170a:170K in which the agent entities 300a:300K are provided. In this respect, based on received data, in terms of computational results, in the reports, the server entity 200 can learn, for example, what sequence of signal quality measurements (e.g. reference signal received power; RSRP) that results in a large signal quality drop. After a model is trained, for instance using the iterative learning process, the server entity 200 can provide the model to the agent entities 300a:300K. The model can be provided either to agent entities 300a:300K having taken part in the training, or to other agent entities 300a:300K. The agent entities 300a:300K can then apply the model to predict future signal quality values. This signal quality prediction can then be used in the context of any of: initiating inter-frequency handover, setting handover and/or reselection parameters, changing device scheduler priority so as to schedule the user equipment 170a:170K when the expected signal quality is good. The data for training such a model is located at the device-side where the agent entities 300a:300K reside, and hence an iterative learning process as disclosed herein can be used to efficiently learn the future signal quality prediction. In particular, the herein disclosed embodiments that achieve added resilience to the reporting of computational results during the iterative learning process can be used to increase the accuracy of the forecasted signal quality prediction. In turn, this enables more accurate initiation of inter-frequency handover, setting of handover and/or reselection parameters, and changing of device scheduler priority.

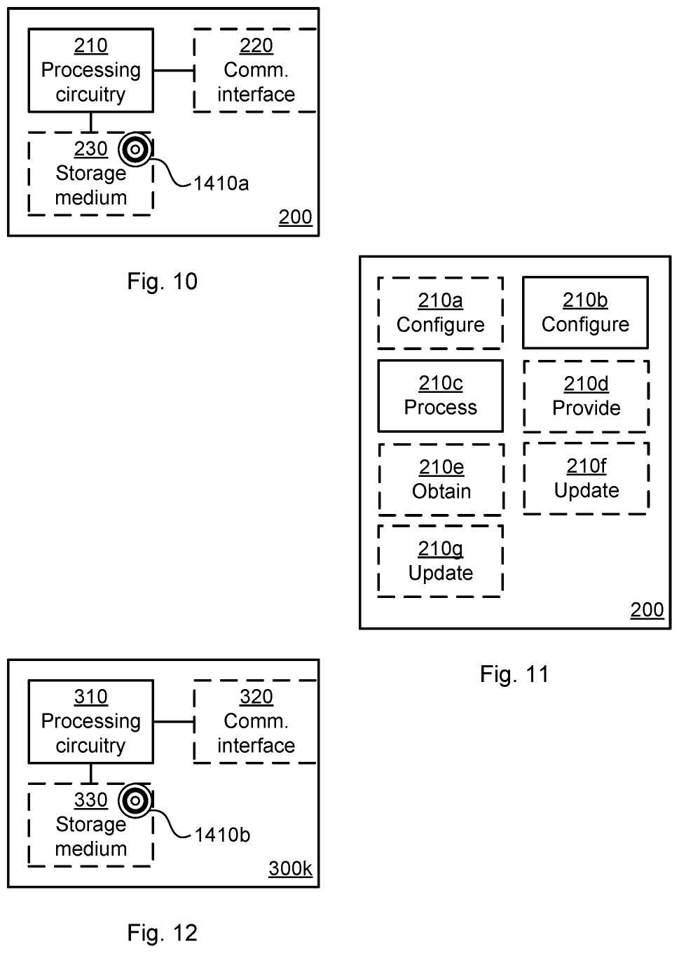

FIG. 10 schematically illustrates, in terms of a number of functional units, the components of a server entity 200 according to an embodiment. Processing circuitry 210 is provided using any combination of one or more of a suitable central processing unit (CPU), multiprocessor, microcontroller, digital signal processor (DSP), etc., capable of executing software instructions stored in a computer program product 1410a (as in FIG. 14), e.g. in the form of a storage medium 230. The processing circuitry 210 may further be provided as at least one application specific integrated circuit (ASIC), or field programmable gate array (FPGA).

Particularly, the processing circuitry 210 is configured to cause the server entity 200 to perform a set of operations, or steps, as disclosed above. For example, the storage medium 230 may store the set of operations, and the processing circuitry 210 may be configured to retrieve the set of operations from the storage medium 230 to cause the server entity 200 to perform the set of operations. The set of operations may be provided as a set of executable instructions. Thus, the processing circuitry 210 is thereby arranged to execute methods as herein disclosed.

The storage medium 230 may also comprise persistent storage, which, for example, can be any single one or combination of magnetic memory, optical memory, solid state memory or even remotely mounted memory.

The server entity 200 may further comprise a communications interface 220 for communications with other entities, functions, nodes, and devices, either directly or indirectly. As such the communications interface 220 may comprise one or more transmitters and receivers, comprising analogue and digital components.

The processing circuitry 210 controls the general operation of the server entity 200 e.g. by sending data and control signals to the communications interface 220 and the storage medium 230, by receiving data and reports from the communications interface 220, and by retrieving data and instructions from the storage medium 230. Other components, as well as the related functionality, of the server entity 200 are omitted in order not to obscure the concepts presented herein.

FIG. 11 schematically illustrates, in terms of a number of functional modules, the components of a server entity 200 according to an embodiment. The server entity 200 of FIG. 11 comprises a number of functional modules; a configure module 210b configured to perform step S104, and a process module 210c configured to perform step S106. The server entity 200 of FIG. 11 may further comprise a number of optional functional modules, such as any of a configure module 210a configured to perform step S102, a provide module 210d configured to perform step S106a, an obtain module 210e configured to perform step S106b, an update module 210f configured to perform step S106c, an update module 210g configured to perform step S106d. In general terms, each functional module 210a:210g may be implemented in hardware or in software. Preferably, one or more or all functional modules 210a:210g may be implemented by the processing circuitry 210, possibly in cooperation with the communications interface 220 and/or the storage medium 230. The processing circuitry 210 may thus be arranged to from the storage medium 230 fetch instructions as provided by a functional module 210a:210g and to execute these instructions, thereby performing any steps of the server entity 200 as disclosed herein.

The server entity 200 may be provided as a standalone device or as a part of at least one further device. Thus, a first portion of the instructions performed by the server entity 200 may be executed in a first device, and a second portion of the instructions performed by the server entity 200 may be executed in a second device; the herein disclosed embodiments are not limited to any particular number of devices on which the instructions performed by the server entity 200 may be executed. Hence, the methods according to the herein disclosed embodiments are suitable to be performed by a server entity 200 residing in a cloud computational environment. Therefore, although a single processing circuitry 210 is illustrated in FIG. 10 the processing circuitry 210 may be distributed among a plurality of devices, or nodes. The same applies to the functional module 210a:210g of FIG. 11 and the computer program 1420a of FIG. 14.

FIG. 12 schematically illustrates, in terms of a number of functional units, the components of an agent entity 300k according to an embodiment. Processing circuitry 310 is provided using any combination of one or more of a suitable central processing unit (CPU), multiprocessor, microcontroller, digital signal processor (DSP), etc., capable of executing software instructions stored in a computer program product 1410b (as in FIG. 14), e.g. in the form of a storage medium 330. The processing circuitry 310 may further be provided as at least one application specific integrated circuit (ASIC), or field programmable gate array (FPGA).

Particularly, the processing circuitry 310 is configured to cause the agent entity 300k to perform a set of operations, or steps, as disclosed above. For example, the storage medium 330 may store the set of operations, and the processing circuitry 310 may be configured to retrieve the set of operations from the storage medium 330 to cause the agent entity 300k to perform the set of operations. The set of operations may be provided as a set of executable instructions. Thus the processing circuitry 310 is thereby arranged to execute methods as herein disclosed.

The storage medium 330 may also comprise persistent storage, which, for example, can be any single one or combination of magnetic memory, optical memory, solid state memory or even remotely mounted memory.

The agent entity 300k may further comprise a communications interface 320 for communications with other entities, functions, nodes, and devices, either directly or indirectly. As such the communications interface 320 may comprise one or more transmitters and receivers, comprising analogue and digital components.

The processing circuitry 310 controls the general operation of the agent entity 300k e.g. by sending data and control signals to the communications interface 320 and the storage medium 330, by receiving data and reports from the communications interface 320, and by retrieving data and instructions from the storage medium 330. Other components, as well as the related functionality, of the agent entity 300k are omitted in order not to obscure the concepts presented herein.

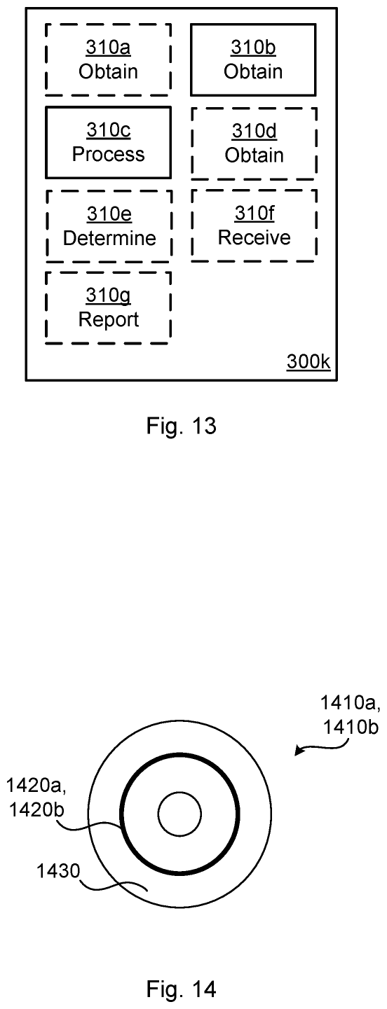

FIG. 13 schematically illustrates, in terms of a number of functional modules, the components of an agent entity 300k according to an embodiment. The agent entity 300k of FIG. 13 comprises a number of functional modules; an obtain module 310b configured to perform step S204, and a process module 310c configured to perform step S206. The agent entity 300k of FIG. 13 may further comprise a number of optional functional modules, such as any of an obtain module 310a configured to perform step S202, an obtain module 310d configured to perform step S206a, a determine module 310e configured to perform step S206b, a receive module 310f configured to perform step S206c, a report module 310g configured to perform step S206d. In general terms, each functional module 310a:310g may be implemented in hardware or in software. Preferably, one or more or all functional modules 310a:310g may be implemented by the processing circuitry 310, possibly in cooperation with the communications interface 320 and/or the storage medium 330. The processing circuitry 310 may thus be arranged to from the storage medium 330 fetch instructions as provided by a functional module 310a:310g and to execute these instructions, thereby performing any steps of the agent entity 300k as disclosed herein. The agent entity 300k may be provided as a standalone device or as a part of at least one further device. Thus, a first portion of the instructions performed by the agent entity 300k may be executed in a first device, and a second portion of the instructions performed by the agent entity 300k may be executed in a second device; the herein disclosed embodiments are not limited to any particular number of devices on which the instructions performed by the agent entity 300k may be executed. Hence, the methods according to the herein disclosed embodiments are suitable to be performed by an agent entity 300k residing in a cloud computational environment. Therefore, although a single processing circuitry 310 is illustrated in FIG. 12 the processing circuitry 310 may be distributed among a plurality of devices, or nodes. The same applies to the functional module 310a:310g of FIG. 13 and the computer program 1420b of FIG. 14.

FIG. 14 shows one example of a computer program product 1410a, 1410b comprising computer readable means 1430. On this computer readable means 1430, a computer program 1420a can be stored, which computer program 1420a can cause the processing circuitry 210 and thereto operatively coupled entities and devices, such as the communications interface 220 and the storage medium 230, to execute methods according to embodiments described herein. The computer program 1420a and/or computer program product 1410a may thus provide means for performing any steps of the server entity 200 as herein disclosed. On this computer readable means 1430, a computer program 1420b can be stored, which computer program 1420b can cause the processing circuitry 310 and thereto operatively coupled entities and devices, such as the communications interface 320 and the storage medium 330, to execute methods according to embodiments described herein. The computer program 1420b and/or computer program product 1410b may thus provide means for performing any steps of the agent entity 300k as herein disclosed.

In the example of FIG. 14, the computer program product 1410a, 1410b is illustrated as an optical disc, such as a CD (compact disc) or a DVD (digital versatile disc) or a Blu-Ray disc. The computer program product 1410a, 1410b could also be embodied as a memory, such as a random access memory (RAM), a read-only memory (ROM), an erasable programmable read-only memory (EPROM), or an electrically erasable programmable read-only memory (EEPROM) and more particularly as a non-volatile storage medium of a device in an external memory such as a USB (Universal Serial Bus) memory or a Flash memory, such as a compact Flash memory. Thus, while the computer program 1420a, 1420b is here schematically shown as a track on the depicted optical disk, the computer program 1420a, 1420b can be stored in any way which is suitable for the computer program product 1410a, 1410b.

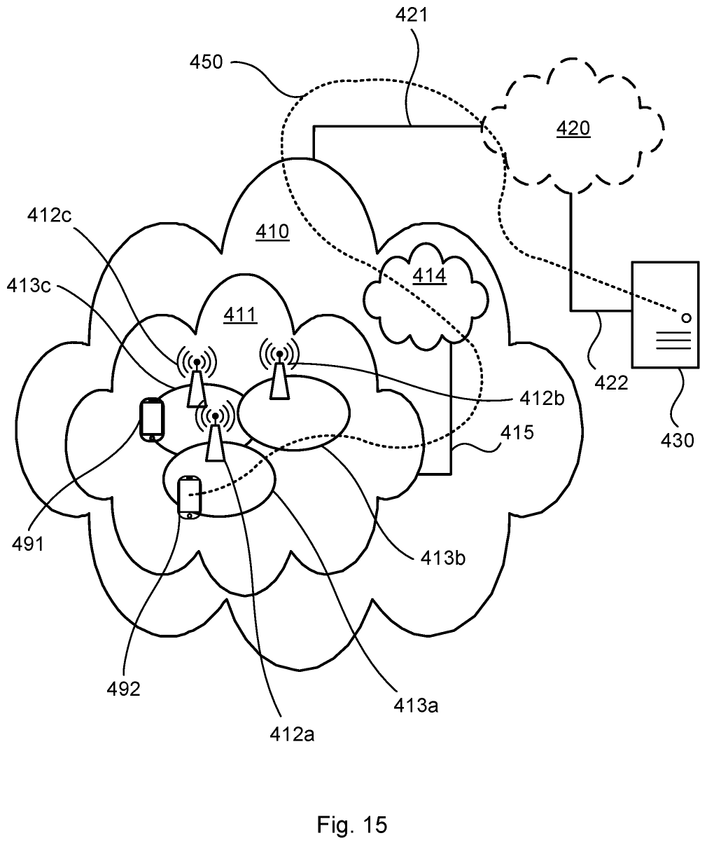

FIG. 15 is a schematic diagram illustrating a telecommunication network connected via an intermediate network 420 to a host computer 430 in accordance with some embodiments. In accordance with an embodiment, a communication system includes telecommunication network 410, such as a 3GPP-type cellular network, which comprises access network 411, such as radio access network 110 in FIG. 1, and core network 414, such as core network 120 in FIG. 1. Access network 411 comprises a plurality of radio access network nodes 412a, 412b, 412c, such as NBs, eNBs, gNBs (each corresponding to the network node 160 of FIG. 1) or other types of wireless access points, each defining a corresponding coverage area, or cell, 413a, 413b, 413c. Each radio access network nodes 412a, 412b, 412c is connectable to core network 414 over a wired or wireless connection 415. A first UE 491 located in coverage area 413c is configured to wirelessly connect to, or be paged by, the corresponding network node 412c. A second UE 492 in coverage area 413a is wirelessly connectable to the corresponding network node 412a. While a plurality of UE 491, 492 are illustrated in this example, the disclosed embodiments are equally applicable to a situation where a sole UE is in the coverage area or where a sole terminal device is connecting to the corresponding network node 412. The UEs 491, 492 correspond to the UEs 170a:17oK of FIG. 1.

Telecommunication network 410 is itself connected to host computer 430, which may be embodied in the hardware and/or software of a standalone server, a cloud-implemented server, a distributed server or as processing resources in a server farm. Host computer 430 may be under the ownership or control of a service provider, or may be operated by the service provider or on behalf of the service provider. Connections 421 and 422 between telecommunication network 410 and host computer 430 may extend directly from core network 414 to host computer 430 or may go via an optional intermediate network 420. Intermediate network 420 may be one of, or a combination of more than one of, a public, private or hosted network; intermediate network 420, if any, may be a backbone network or the Internet; in particular, intermediate network 420 may comprise two or more sub-networks (not shown).

The communication system of FIG. 15 as a whole enables connectivity between the connected UEs 491, 492 and host computer 430. The connectivity may be described as an over-the-top (OTT) connection 450. Host computer 430 and the connected UEs 491, 492 are configured to communicate data and/or signalling via OTT connection 450, using access network 411, core network 414, any intermediate network 420 and possible further infrastructure (not shown) as intermediaries. OTT connection 450 may be transparent in the sense that the participating communication devices through which OTT connection 450 passes are unaware of routing of uplink and downlink communications. For example, network node 412 may not or need not be informed about the past routing of an incoming downlink communication with data originating from host computer 430 to be forwarded (e.g., handed over) to a connected UE 491. Similarly, network node 412 need not be aware of the future routing of an outgoing uplink communication originating from the UE 491 towards the host computer 430.

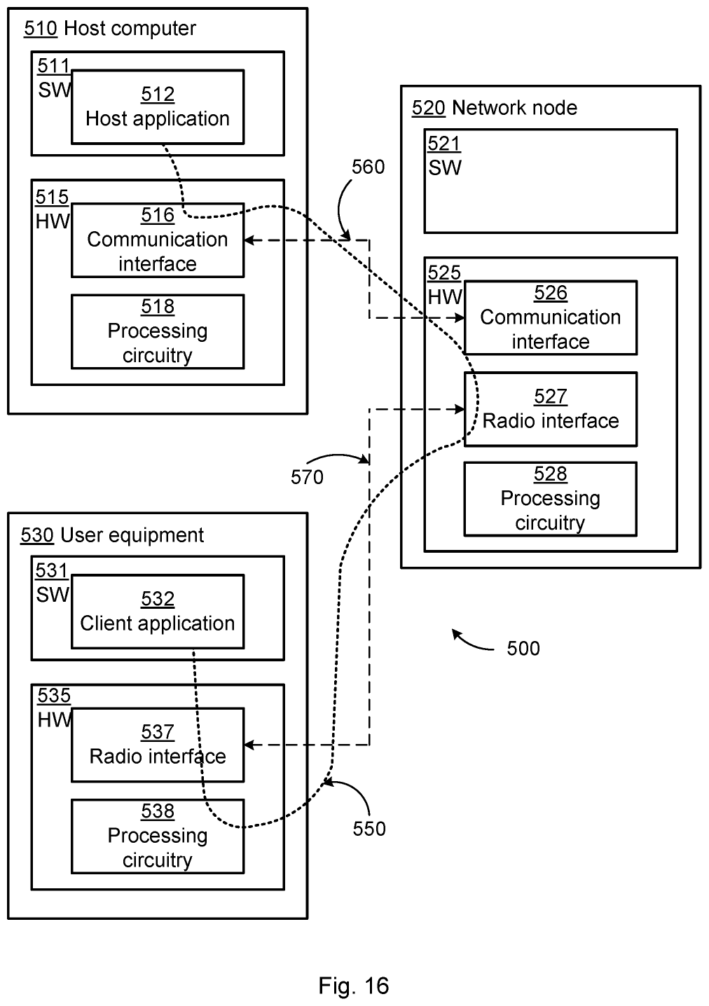

FIG. 16 is a schematic diagram illustrating host computer communicating via a radio access network node with a UE over a partially wireless connection in accordance with some embodiments. Example implementations, in accordance with an embodiment, of the UE, radio access network node and host computer discussed in the preceding paragraphs will now be described with reference to FIG. 16. In communication system 500, host computer 510 comprises hardware 515 including communication interface 516 configured to set up and maintain a wired or wireless connection with an interface of a different communication device of communication system 500. Host computer 510 further comprises processing circuitry 518, which may have storage and/or processing capabilities. In particular, processing circuitry 518 may comprise one or more programmable processors, application-specific integrated circuits, field programmable gate arrays or combinations of these (not shown) adapted to execute instructions. Host computer 510 further comprises software 511, which is stored in or accessible by host computer 510 and executable by processing circuitry 518. Software 511 includes host application 512. Host application 512 may be operable to provide a service to a remote user, such as UE 530 connecting via OTT connection 550 terminating at UE 530 and host computer 510. The UE 530 corresponds to the UEs 170a:17oK of FIG. 1. In providing the service to the remote user, host application 512 may provide user data which is transmitted using OTT connection 550.

Communication system 500 further includes radio access network node 520 provided in a telecommunication system and comprising hardware 525 enabling it to communicate with host computer 510 and with UE 530. The radio access network node 520 corresponds to the network node 160 of FIG. 1. Hardware 525 may include communication interface 526 for setting up and maintaining a wired or wireless connection with an interface of a different communication device of communication system 500, as well as radio interface 527 for setting up and maintaining at least wireless connection 570 with UE 530 located in a coverage area (not shown in FIG. 16) served by radio access network node 520. Communication interface 526 may be configured to facilitate connection 560 to host computer 510. Connection 560 may be direct or it may pass through a core network (not shown in FIG. 16) of the telecommunication system and/or through one or more intermediate networks outside the telecommunication system. In the embodiment shown, hardware 525 of radio access network node 520 further includes processing circuitry 528, which may comprise one or more programmable processors, application-specific integrated circuits, field programmable gate arrays or combinations of these (not shown) adapted to execute instructions. Radio access network node 520 further has software 521 stored internally or accessible via an external connection.

Communication system 500 further includes UE 530 already referred to. Its hardware 535 may include radio interface 537 configured to set up and maintain wireless connection 570 with a radio access network node serving a coverage area in which UE 530 is currently located. Hardware 535 of UE 530 further includes processing circuitry 538, which may comprise one or more programmable processors, application-specific integrated circuits, field programmable gate arrays or combinations of these (not shown) adapted to execute instructions. UE 530 further comprises software 531, which is stored in or accessible by UE 530 and executable by processing circuitry 538. Software 531 includes client application 532. Client application 532 may be operable to provide a service to a human or non-human user via UE 530, with the support of host computer 510. In host computer 510, an executing host application 512 may communicate with the executing client application 532 via OTT connection 550 terminating at UE 530 and host computer 510. In providing the service to the user, client application 532 may receive request data from host application 512 and provide user data in response to the request data. OTT connection 550 may transfer both the request data and the user data. Client application 532 may interact with the user to generate the user data that it provides.

It is noted that host computer 510, radio access network node 520 and UE 530 illustrated in FIG. 16 may be similar or identical to host computer 430, one of network nodes 412a, 412b, 412c and one of UEs 491, 492 of FIG. 15, respectively. This is to say, the inner workings of these entities may be as shown in FIG. 16 and independently, the surrounding network topology may be that of FIG. 15.

In FIG. 16, OTT connection 550 has been drawn abstractly to illustrate the communication between host computer 510 and UE 530 via network node 520, without explicit reference to any intermediary devices and the precise routing of messages via these devices. Network infrastructure may determine the routing, which it may be configured to hide from UE 530 or from the service provider operating host computer 510, or both. While OTT connection 550 is active, the network infrastructure may further take decisions by which it dynamically changes the routing (e.g., on the basis of load balancing consideration or reconfiguration of the network).

Wireless connection 570 between UE 530 and radio access network node 520 is in accordance with the teachings of the embodiments described throughout this disclosure. One or more of the various embodiments improve the performance of OTT services provided to UE 530 using OTT connection 550, in which wireless connection 570 forms the last segment. More precisely, the teachings of these embodiments may reduce interference, due to improved classification ability of airborne UEs which can generate significant interference.

A measurement procedure may be provided for the purpose of monitoring data rate, latency and other factors on which the one or more embodiments improve. There may further be an optional network functionality for reconfiguring OTT connection 550 between host computer 510 and UE 530, in response to variations in the measurement results. The measurement procedure and/or the network functionality for reconfiguring OTT connection 550 may be implemented in software 511 and hardware 515 of host computer 510 or in software 531 and hardware 535 of UE 530, or both. In embodiments, sensors (not shown) may be deployed in or in association with communication devices through which OTT connection 550 passes; the sensors may participate in the measurement procedure by supplying values of the monitored quantities exemplified above, or supplying values of other physical quantities from which software 511, 531 may compute or estimate the monitored quantities. The reconfiguring of OTT connection 550 may include message format, retransmission settings, preferred routing etc.; the reconfiguring need not affect network node 520, and it may be unknown or imperceptible to radio access network node 520. Such procedures and functionalities may be known and practiced in the art. In certain embodiments, measurements may involve proprietary UE signalling facilitating host computer's 510 measurements of throughput, propagation times, latency and the like. The measurements may be implemented in that software 511 and 531 causes messages to be transmitted, in particular empty or ‘dummy’ messages, using OTT connection 550 while it monitors propagation times, errors etc.

The inventive concept has mainly been described above with reference to a few embodiments. However, as is readily appreciated by a person skilled in the art, other embodiments than the ones disclosed above are equally possible within the scope of the inventive concept, as defined by the appended patent claims.

1. A method for configuring agent entities with a reporting schedule for reporting computational results during an iterative learning process, the method being performed by a server entity, the method comprising:
configuring the agent entities with a computational task and a reporting schedule,
wherein the reporting schedule defines pairs of the agent entities, wherein, according to the reporting schedule and per each iteration of the learning process, each of the agent entities in each pair is to report its own computational result of the computational task to both the server entity and the other of the agent entities in the same pair, and when reporting its own computational result to the server entity, each of the agent entities is to superimpose the computational result of the other of the agent entities in the same pair; and
performing the iterative learning process with the agent entities until a termination criterion is met.

2. The method according to claim 1, wherein which of the agent entities to be paired with each other is dependent on at least one of:
channel quality between the server entity and each of the agent entities, channel quality between the agent entities themselves,
geographical location of each of the agent entities,
device information of each of the agent entities,
device capability of each of the agent entities,
amount of data locally obtainable by each of the agent entities.

3. The method according to claim 1, wherein the method further comprises:
configuring the agent entities to, to the server entity, report parameters affecting pairing of the agent entities.

4. The method according to claim 3, wherein the parameters affecting the pairing pertain to at least one of:
channel quality between the server entity and each of the agent entities, channel quality between the agent entities themselves,
geographical location of each of the agent entities,
device information of each of the agent entities,
device capability of each of the agent entities,
amount of data locally obtainable by of each of the agent entities.

5. The method according to claim 1, wherein the method further comprises:
updating the reporting schedule for a next iteration of the iterative learning process based on the computational results received for a current iteration of the iterative learning process.

6. The method according to claim 1, wherein, according to the reporting schedule, each of the agent entities in each pair is configured to, as part of superimposing the computational result of the other of the agent entities, weighting its own computational result with a first weighting factor and weighting the computational result of the other of the agent entities with a second weighting factor.

7. The method according to claim 1, wherein, according to the reporting schedule, only one of the agent entities in each pair is configured to, as part of superimposing the computational result of the other of the agent entities, weighting its own computational result with a first weighting factor and weighting the computational result of the other of the agent entities with a second weighting factor.

8. The method according to claim 1, wherein, as part of performing the iterative learning process with the agent entities, the computational results of the agent entities are received over wireless links, wherein the server entity obtains link quality measurements of the wireless links, and wherein any computational result received over a wireless link with a link quality, as indicated by the link quality measurement for said wireless link, is below a quality threshold is disregarded.

9. The method according to claim 1, wherein, according to the reporting schedule, the agent entities are configured to, when reporting their own computational result to the server entity, indicate whether the computational result of the other of the agent entities in the same pair has been superimposed or not.

10. The method according to claim 1, wherein the server entity during each iteration of the iterative learning process:
provides a parameter vector of the computational task to the agent entities;
obtains, according to the reporting schedule, superpositions of computational results as a function of the parameter vector from the agent entities; and
updates the parameter vector as a function of an aggregate of the obtained computational results when the aggregate of the obtained computational results for the iteration fails to satisfy the termination criterion.

11. The method according to claim 1, wherein the computational task pertains to prediction of best secondary carrier frequencies based on measurements on a first carrier frequency to be used by user equipment in which the agent entities are provided.

12. The method according to claim 1, wherein the computational task pertains to compressing channel-state-information using an auto-encoder, wherein the server entity implements a decoder of the auto-encoder, and wherein each of the agent entities implements a respective encoder of the auto-encoder.

13. The method according to claim 1, wherein the computational task pertains to signal quality drop prediction based on measurements on wireless links used by user equipment in which the agent entities are provided.

14. The method according to claim 1, wherein the server entity is provided in a network node, and each of the agent entities is provided in a respective user equipment.

15. A method for being configured by a server entity with a reporting schedule for reporting computational results during an iterative learning process, the method being performed by an agent entity, the method comprising:
obtaining configuring in terms of a computational task and a reporting schedule from the server entity,
wherein the reporting schedule defines pairs of agent entities, wherein the agent entity belongs to one of the pairs of agent entities, and wherein, according to the reporting schedule and per each iteration of the learning process, each of the agent entities in each pair is to report its own computational result of the computational task to both the server entity and the other of the agent entities in the same pair, and when reporting its own computational result to the server entity, each of the agent entities is to superimpose the computational result of the other of the agent entities in the same pair; and
performing the iterative learning process with the server entity until a termination criterion is met, wherein, as part of performing the iterative learning process, the agent entity reports a computational result for an iteration of the learning process according to the reporting schedule.

16. The method according to claim 15, wherein the method further comprises:
obtaining configuring from the server entity to, to the server entity, report parameters affecting pairing of the agent entity.

17.-26. (canceled)

27. A server entity for configuring agent entities with a reporting schedule for reporting computational results during an iterative learning process, the server entity comprising processing circuitry, the processing circuitry being configured to cause the server entity to:
configure the agent entities with a computational task and a reporting schedule,
wherein the reporting schedule defines pairs of the agent entities, wherein, according to the reporting schedule and per each iteration of the learning process, each of the agent entities in each pair is to report its own computational result of the computational task to both the server entity and the other of the agent entities in the same pair, and when reporting its own computational result to the server entity, each of the agent entities is to superimpose the computational result of the other of the agent entities in the same pair; and
perform the iterative learning process with the agent entities until a termination criterion is met.

28. (canceled)

29. (canceled)

30. An agent entity for being configured by a server entity with a reporting schedule for reporting computational results during an iterative learning process, the agent entity comprising processing circuitry, the processing circuitry being configured to cause the agent entity to:
obtain configuring in terms of a computational task and a reporting schedule from the server entity,
wherein the reporting schedule defines pairs of agent entities, wherein the agent entity belongs to one of the pairs of agent entities, and wherein, according to the reporting schedule and per each iteration of the learning process, each of the agent entities in each pair is to report its own computational result of the computational task to both the server entity and the other of the agent entities in the same pair, and when reporting its own computational result to the server entity, each of the agent entities is to superimpose the computational result of the other of the agent entities in the same pair; and
perform the iterative learning process with the server entity until a termination criterion is met, wherein, as part of performing the iterative learning process, the agent entity reports a computational result for an iteration of the learning process according to the reporting schedule.

31. (canceled)

32. (canceled)

33. A computer program product for configuring agent entities with a reporting schedule for reporting computational results during an iterative learning process, the computer program product comprising a non-transitory computer readable medium storing computer code which, when run on processing circuitry of a server entity, causes the server entity to carry out the method according to claim 1.

34. A computer program product for being configured by a server entity with a reporting schedule for reporting computational results during an iterative learning process, the computer program product comprising a non-transitory computer readable medium storing computer code which, when run on processing circuitry of an agent entity, causes the agent entity to carry out the method according to claim 15.

35. (canceled)
